(19) United States
(12) Patent Application Publication
(10) Pub. No.: US 2013/0024314 A1
(43) Pub. Date: Jan. 24, 2013

(54) METHOD OF SELLING ITEMS

(71) Applicant: Bobby W. BRAXTON, Plano, TX (US)

(72) Inventor: Bobby W. BRAXTON, Plano, TX (US)

(21) Appl. No.: 13/187,062

(22) Filed: Jul. 20, 2011

(51) Int. Cl. G06Q 30/00

(52) U.S. Cl. 705/26.3

(57) ABSTRACT

A method of selling items. In one embodiment the method comprising soliciting at least one bid for said at least one item from at least one potential buyer, wherein at least one of said at least one bids comprises a bid fee and a bid price. A winning bid is received from a winning buyer, wherein said winning bid comprises a winning price. Next, at least a portion of said winning price and at least a portion of said bid fee are remitted to said buyer. In one embodiment the bidding takes place on a third-party website.

### BACKGROUND OF THE INVENTION

1. Technical Field

The present invention relates to a method of selling items.

2. Description of Related Art

Buyers began buying items from sellers as soon as humans became able to communicate. There are many different methods for selling an item. The traditional retail method comprises a seller affixing a price to an item. If the price is acceptable to the buyer, the sale is consummated. Other methods of selling include auctions whereby competing buyers out bid one another in an attempt to “win” the item. Many of these methods are insufficient. Typically, in each sale there is a “winner” and a “loser.” If the buyer receives a favorable price this is typically at the expense of the seller, and vice versa. Consequently, there is a need for a novel method of selling which overcomes the disadvantages of the prior art.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic of a method of selling an item in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

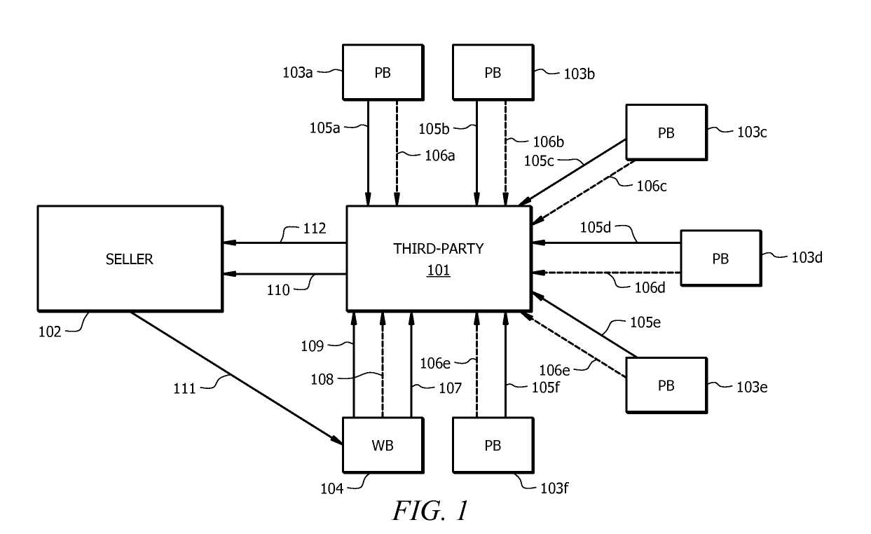

FIG. 1 is a schematic of a method of selling an item in one embodiment. A solid line represents an actual transfer whereas a dashed line represents a bid or other promise to pay. As used herein “sell” refers to any exchange of consideration for an item. In one embodiment this includes selling an item in the traditional sense whereby ownership of an item is transferred. In another embodiment this includes an offer for lease or rent. Thus, when a landlord rents property that is considering selling of property herein.

The item can include tangible and non-tangible property. The item can include any item which can be sold, including but not limited to, pieces of technology such as televisions, cameras, or computers, books, video games, gift certificates, etc. The items can be new or used. Further, the item can include stock, bonds, etc. Additionally, the item can include non-tangible property such as intellectual property. In one embodiment the item includes a service, for example, a car wash or a house cleaning Virtually any item that can be bought or sold can be bought or sold with the method herein.

Referring to FIG. 1, a third-party 101 is in contact with a seller 102. As noted above, a seller 102 is someone who desires to sell an item. A third-party 101 refers to any individual, company, or machine which coordinates the sale between a seller 102 and a buyer. In one embodiment the third-party 101 is a website. In another embodiment the third-party 101 is an auction house. In one embodiment the third-party 101 hosts an auction. This auction can be live, in person, or on-line. The auction can comprise a single item or multiple items being sold.

Contact is made between the seller 102 and the third-party 101. The contact can be initiated by either party. In one embodiment, the seller 102 contacts the third-party 101. The contact can be in response to an inquiry from the third-party 101 to the seller 102, or the seller 102 can simply approach the third-party 101. In one embodiment wherein the third-party 101 is a website, the seller 102 contacts the third-party 101 by logging-into or otherwise engaging the website. The seller 102 offers to sell at least one item 111 through said third-party 101.

The seller 102 instructs the third-party 101 that the seller 102 would like to sell an item 111. In one embodiment the third-party 101 collects information about the item 111 that would be useful in selling the item such as a description of the item, whether is new or used, a retail price of the item, a picture of the item, model number, etc.

Next, the third-party 101 solicits at least one bid from at least one potential buyer 103. As depicted in FIG. 1 there are six potential buyers (PB) 103a-103f. In one embodiment soliciting comprises actively soliciting, which means contacting potential buyers to see if they are interested in the item 111. For example, in one embodiment the third-party 101 contacts potential buyers 103 which it believes may have an interest in the item 111. As an example, potential buyers 103 may register an interest in a particular group of items. This interest may be expressly entered by the potential buyer by, for example, communicating to the third-party 101 that they are interested in a specific item or items. This can be done, for example, when the potential buyer 103 registers with the third-party 101. In other embodiments the interest may be implied. For example, the third-party 101 may be aware that the potential buyer 103 previously placed a bid for a particular item. When active soliciting is utilized, the third-party 101 can use information to actively seek out potential buyers 103. In one embodiment active solicitation comprises utilizing a database which stores data regarding potential buyers. As an example, if a seller desires to sell a television, if potential buyer 103 has previously bid on televisions, the third-party 101 can communicate with the potential buyer 103 to inform the buyer of the item for sale, which helps to create interest in the item. In one embodiment, the communication comprises an email from the third-party 101 to the potential buyer 103.

In another embodiment soliciting comprises passive soliciting whereby the third-party 101 simply collects bids from the potential buyers 103. In one embodiment of passive soliciting, potential buyers 103 are not individually contacted. Rather, potential buyers 103 simply review the items being sold. In passive soliciting the burden is on the potential buyer 103 to become aware of and bid on the item. In one embodiment wherein the third-party 101 comprises a website, potential buyers 103 view the item or items for sale on said website. In one embodiment the soliciting comprises accepting bids submitted through a computer. In one embodiment a combination of active and passive soliciting is used.

The potential buyers 103 can comprise any party desiring to purchase an item including an individual, a corporation, etc. Where the third-party 101 is a website, potential buyers 103 comprise visitors to the website. When a potential buyer 103 desires to make a bid on an item 111, the potential buyer 103 transmits a bid price 106 to the third-party 101. The transmission can be visual, audio, or electronic. If the third-party 101 is a website, the potential buyer 103 can click “bid” for example. The bid is then transmitted from the potential buyer's 103 computer to the third-party 101. Thus, in one embodiment the bid is transmitted via communication between two or more computers. The bid price 106 is the price which the potential buyer 103 offers to pay for the item 111.

In one embodiment the bid price 106 is determined by the potential buyer 103. For example, if the first potential buyer 103a bids $100, the second potential buyer 103b can determine if the bid price 106b is going to be $100.01, $101, $110, $200, etc. This embodiment is referred to herein as a buyer set bid price 106. In the buyer set bid price 106 embodiment, the buyer determines the bid price increment, or the difference between the current and prior bid price. As noted, the second potential buyer 103b may submit a bid price 106b of $110, which is a bid price increment of $10 over the prior bid price, whereas the second potential buyer 103c may increase the bid price to $140 which is a bid price increment of $30. Thus, the bid price increment is not necessarily constant.

In another embodiment the bid price increment is specified by the third-party 101. For example, the third-party 101 can specify a bid price increment of $1.00. In such a scenario if the first bid price 106a is $100, the second bid price 103b must be $101. Likewise, in one embodiment the bid price increment is set by the seller 102. In one embodiment, the seller 102 and the third-party 101 together determine the bid price increment.

In one embodiment a sale comprises multiple bid price increments. As an example, during the first several bids, or until a desired bid price has been achieved, a first bid-price increment is specified. After the desired bid price has been received, a second price increment is specified. To illustrate, the first bid-price increment is set at $10 until a bid price of $100 is achieved wherein the bid-price increment is reduced to $1.00. In one embodiment the bid price increment is static until the happening of an event, for example after the desired bid price has been received.

Virtually any bid-price increment can be utilized. In one embodiment bid-price increments ranges from $0.005 to $1,000. In one embodiment the bid-price increment is $0.01. In another embodiment the bid-price increment ranges from about $0.05 to about $0.50, whereas in still other embodiments the bid-price increment ranges from about $0.50 to $1.00.

In one embodiment, when a potential buyer 103 submits a bid price 106, the potential buyer 103 must also submit a bid fee 105. A bid fee 105 refers to a fee associated with submitting a bid price 106. The bid fee 105 can be paid in any method known in the art. The bid fee 105 can be paid via cash, credit card, Pay-pal, or on credit. In one embodiment when the potential buyer 103 registers with the third-party 101, the potential buyer 103 submits an account number, credit card number, or other method of payment. In one embodiment the bid fee 105 is collected at the time the bid price 106 is submitted, whereas in other embodiments the bid fee 105 is collected sometime after the sale is complete. In another embodiment the bid fee 105 is collected before the potential buyer 103 can submit a bid price 106. In one embodiment, the bid fee 105 is submitted to the third-party 101.

The bid fee 105 can be set by the third-party 101, the seller 102, or a combination thereof. The bid fee 105 can be any value. In one embodiment the bid fee 105 ranges from about $0.005 to $1,000.00. In one embodiment the bid fee ranges from about $0.05 to about $1.00. In another embodiment the bid fee ranges from about $0.20 to about $0.70, whereas in another embodiment the bid fee ranges from about $0.35 to about $0.60.

The first bid price 106 can be set in a variety of ways. In one embodiment the potential buyer 103a determines the bid price 106. In another embodiment the third-party 101 determines the first bid price 106. In yet another embodiment the seller 102 determines the first bid price 106.

Returning to FIG. 1, the winning buyer 104 submits the winning bid price 108. It should be noted that the winning buyer 104 is considered a potential buyer 103 until the bid price 106 turns becomes the winning bid price 108. There are a variety of methods used to determine the winning bid price 108. In one embodiment there is a set time for soliciting bids. Therefore, the final bid price submitted is the winning bid price 108. This embodiment is referred to as the simple auction embodiment. As used herein a simple auction refers to an auction which has a time period which does not reset. Therefore, if a simple auction is set for 24 hours, the bid price 106 at the expiration of 24 hours becomes the winning bid price 108. Simultaneously the last potential buyer 103 becomes the winning buyer 104.

In another embodiment a resetting auction is utilized. A resetting auction is an auction which has a time period reset if a new bid price 106 has been submitted before a specified amount of time. The new bid price 106 becomes the winning bid price 108 only after the expiration of a specified amount of time. This specified amount of time can comprise any time period, including but not limited to a period from 1 second to several days or weeks. In another embodiment the specified time in a resetting auction ranges from about 5 seconds to about 2 minutes, whereas in other embodiments the specified time ranges from about 10 seconds to about 40 seconds. As an example if the specified amount of time is 10 seconds, the bid price 106 becomes the winning bid price 108 after 10 seconds has passed without receiving a new bid price 106. If a new bid price 106 is placed with five seconds remaining, then the clock resets and the new bid price 106 will become the winning bid price 108 after the expiration of 10 seconds.

In one embodiment a resetting auction does not begin to reset until after an initial time passage. For example, assume the initial time passage is 24 hours and the specified amount of time before reset is 10 seconds. During the first 24 hours the clock does not reset. Instead, only after the expiration of 24 hours does the specified amount of time begin to reset. Thus, in such an embodiment a bid price 106 can be submitted at hour 12 but nothing happens until after the passage of 24 hours. Thereafter, 10 seconds must pass without an additional bid price 106 before the bid price 106 becomes the winning bid price 108.

In another embodiment the winning bid price 108 is set by the seller 102, the third-party 101, or a combination thereof. This is referred to as a set winning bid price 108. In such an embodiment, as soon as the winning bid price 108 submitted by a potential buyer 103 is equal to or greater than the set winning bid price 108, the auction is closed. In one embodiment the set winning bid price 108 is known to the potential buyer 103 whereas in other embodiments the set winning bid price 108 is unknown to the potential buyer 103. In one embodiment a set winning bid price 108 is utilized with a buyer set bid price 106. Thus, if the buyer 103 submits a bid price 106 equal to or greater than the winning bid price 108, the auction is closed.

After the winning buyer 104 submits the winning bid price 108, the sale is complete and additional bids are not accepted. Thereafter, the winning buyer 104 must pay the purchase price 109.

The purchase price 109 can be paid with any of the payment methods discussed herein. In one embodiment the purchase price 109 is the same as the winning bid price 108. Thus, if the winning bid price 108 was $100 then the purchase price 109 is also $100. In other embodiments, however, the purchase price 109 is the winning bid price 108 less any discounts. For example, in one embodiment the discounts comprise all or a portion of the bid fees paid by the winning buyer 104. If the winning buyer 104 paid $10 in bid fees, and the winning bid price 108 was $100, then the final purchase price 109 is the winning bid price 108 less bid fees 105 for a value of $90. In such an embodiment, the winning buyer 104 gets a credit for any bid fee 105 paid. In other embodiments the winning buyer 104 gets a credit for only a portion of bid fees 105 paid.

In one embodiment there are two values paid to the seller 102. The first value is the purchase payout 112. This is the amount which is directly attributable to the sale of the item. In one embodiment the purchase payout 112 is equal to the winning bid price 108. The second value is the bid fee payout 110. The bid fee payout 110 is based upon the total bid fees collected. In one embodiment, the total bid fees collected is a sum of all of the cumulative bid fees 105 which were collected. The bid fee payout 110 can be a portion of or the entire amount of the total bid fees collected. In one embodiment the bid fee payout 110 ranges from 0.01% to about 100% of the total bid fees collected, whereas in other embodiments the bid fee payout 110 ranges from about 10% to about 80% of the total bid fees collected. In another embodiment the bid fee payout 110 ranges from about 35% to about 55% of the total bid fees collected whereas in other embodiments the bid fee payout 110 ranges from about 40% to about 50% of the total bid fees collected. Thus, in one embodiment the method further comprises calculating the cumulative bid fees and remitting at least a portion of the cumulative bid fees to the winning buyer. In one embodiment the total bid fees collected excludes bid fees credited to the winning buyer 104.

In one embodiment the winning buyer 104 pays the third-party 101. This embodiment is illustrated in FIG. 1. Thus, in one embodiment the winning buyer 104 submits the winning bid fee 107 and the purchase price 109 to the third-party 104. Thereafter, the third-party 101 submits the bid fee payout 110 and the purchase payout 112 to the seller 102. In another embodiment the winning buyer 104 pays the seller 102.

A few illustrative embodiments are shown below. The embodiments are for illustrative purposes only and should not be deemed limiting.

### Example 1

Referring to FIG. 1, assume a bid fee 105 of $10, a bid price increment price of $100, and an initial bid of $0. Also assume the winning buyer 104 does not receive any credits for any bid fees 105. Also assume the bid fee payout 110 is 50% of the total bid fees collected. The first potential buyer 103a submits a bid price 106a of $100. The first potential buyer 103a must also submit a bid fee 105a of $10. Thereafter the second potential buyer 103b submits a bid price 106b of $200 and a bid fee 105b of $10. Next the third potential buyer 103c submits a bid price 106c of $300 and a bid fee 105c of $10. The same happens with the fourth 103d and fifth 103e potential buyers as well. Thereafter, the sixth potential buyer 103f submits a bid price 106f of $600 and a bid fee 105f of $10. Finally, the seventh potential buyer, which in FIG. 1 is the winning buyer 104, submits the winning bid price 108 of $700. No one outbids the seventh potential purchaser, and thus, the winning buyer 104 wins the auction.

In the scenario above the purchase price 109 is $700. The winning buyer 104 then pays the third-party 101 a total of $800 for the item, which includes the purchase price 109 of $700 as well as the winning bid fee 107 of $100. The seller 102 then receives the purchase payout 112 of $700. The seller 102 would also receive the bid fee payout 110 of $35, which is 50% of $70.

### Example 2

Referring to FIG. 1, assume a bid fee 105 of $0.50, a bid price increment price of $0.01, and an initial bid of 0$. Also assume the winning buyer 104 does not receive any credits for any bid fees 105. Also assume the bid fee payout 110 is 50% of the total bid fees collected.

The seller 102 is selling a camera valued at $100. The winning bid price 108 is $10. At bid price increments of $0.01, this means that 1,000 bids were submitted, each at $0.50. Accordingly, the total bid fees collected is $500. The seller 102 then receives the purchase payout 112 of $10 as well as the bid fee payout 110 of $250, which is 50% of the total bid fees collected. Thus, the seller 102 sold the camera worth $100 for a price of $260 ($10+$250). The seller 102 is very excited. Likewise, the winning buyer 104 purchased a camera valued at $100 for $10.01. Thus, both the seller 102 and the winning buyer 104 are very happy.

Refer back to Example 2. Assume now that the winning bid price 108 is $1.00. In such a situation the seller 102 sells a camera valued at $100 for the purchase payout 112 of $1.00 as well as the seller's portion of the bid fee payout 110 of $25. In such a situation the seller 102 may be unhappy with selling a camera valued at $100 for $26. Perhaps the seller 102 may refuse to transfer the item to the winning buyer 104, leaving the third-party 101 potentially liable for the cost of the item 111. There are a variety of methods to account for this situation. First, as noted above, in one embodiment the seller 102 can specify the first bid price 106. The seller 102 can set the first bid price 106 at any price. Therefore, the potential buyer 103 must submit a bid price 106 greater than or equal to the first bid price 106 to register a bid. In one embodiment this method decreases the total bid fees 105 collected. As an example, if the minimum first bid price 106 was set for $30 and the winning bid price 108 for the camera was $35, the purchase payout 112 is $35 and the seller's 102 portion of the bid fee payout 110 is $125 (50% of $250). Thus, the seller 102 sold a camera valued at $100 for $160 ($125+$35). In one embodiment potential buyers 103 prefer the method wherein the seller 102 sets a minimum first bid price 106. There are many unexpected advantages to this arrangement. Many potential buyers can be pessimistic that they will win the bid when the bid price 106 is very low. Keeping with the camera example, potential buyers can be hesitant to submit a bid price 106 of $0.02, feeling that they will likely be outbid resulting in a waste of the bid fee 105. However, if the bid price 106 has already been raised to a sufficient level, for example $30 as used above, potential buyers 103 believe a bid is worth submitting as they believe it could be a winning bid. Additionally, because any winning bid price 108 will be greater than the minimum first bid price 106 specified by the seller 102, the seller 102 is more likely to be satisfied with the sale and thus more likely to follow through with the transaction.

Another method to prevent the seller 102 from refusing to transfer the item 111 is to secure collateral from the seller 102. This is counterintuitive as it is unheard for a third-party to collect collateral from a seller when coordinating a sale between a seller 102 and a potential buyer 103. The collateral can be virtually any amount. In one embodiment collateral is equal to the retail value of the item 111. In another embodiment the collateral is equal to the value of the winning bid price 108. The collateral can be collected before, after, or during the transaction. In one embodiment the seller 102 agrees to authorize the third-party 101 to collect collateral before, after, or during the transaction. This authorization can include any method of securing collateral, including but not limited to, obtaining authorization to draw on the seller's 102 bank account, authorization to charge or place a hold on the seller's credit card, etc. In one embodiment the collateral is actually transferred from the seller 102 to the third-party whereas in other embodiments the collateral is transferred only if a triggering event occurs. A triggering event is any event which results in an incomplete transaction. As used herein a complete transaction refers to a situation wherein the seller 102 has transferred the item 111 to either the third-party 101 or the winning buyer 104, and the winning buyer 104 has transferred the winning bid price 108 to either the third-party 101 or the seller. Anything less than the previously stated is referred to as an incomplete transaction. A triggering event includes the seller's 102 refusal to transfer the item 111, the item 111 not arriving to the third-party 101 or the winning buyer 104 in the condition specified, the winning buyer's 104 refusal to pay, and other such situations which result in an incomplete transaction.

One embodiment further comprises the step of verifying that the item has been transferred to the winning buyer 104. In one embodiment the verifying occurs prior to remitting at least a portion of the bid fees to the winning buyer 104. In one embodiment the verifying occurs after remitting at least a portion of the bid fees to the winning buyer. The verifying can be an express verification wherein either the seller or the winning buyer expressly verify. In other embodiments verification is assumed if the third-party 101 is not notified of a triggering event.

In one embodiment after the transaction is complete the third-party 101 transfers the seller's collateral back to the seller 102. In other embodiments collateral is not taken until a triggering event occurs which results in an incomplete transaction. In some embodiments, for example after some triggering events wherein the seller 102 refuses to transfer the item 111, the collateral is retained by the third-party 101. The third-party 101 can keep the entire collateral, or can transfer a portion or the entire collateral to the winning buyer 104. In one embodiment, following an incomplete transaction the winning buyer 104 is credited with all or a portion of fees paid by the winning buyer 104. In one embodiment, all or a portion of all potential buyers 103 are credited for all or a portion of all fees paid by the potential buyers 103. Regarding the wining buyer 104, in one embodiment involving an incomplete transaction, the third-party 101 makes the winning buyer 104 whole again. As used herein, “whole again” refers to placing a party in the same position financially that they would have been in had the transaction been complete. In one embodiment, making the winning buyer 104 whole again comprises transferring to the winning buyer 104 a similar item 111 to the item 111 that the wining buyer 104 won. For example, if the item 111 was a new camera with a retail value of $100 and the seller 102 refused to transfer, one possibility of making the winning buyer 104 whole comprises transferring a camera with a retail value of $100 to the winning buyer 104. In one such embodiment, the third-party 101 retains fees previously paid by the winning buyer 104 and then transfers a similar item 111 to the potential buyer 103. In another embodiment making the winning buyer 104 whole again comprises providing the winning buyer 104 credit in the amount of the difference between the value of the item 111 and the fees paid by the winning buyer 104. For example, if the winning buyer 104 was supposed to receive a camera with a value of $100 for a total cost to the winning buyer 104 (including the fee and the bid price) of $10, then the winning buyer 104 would be transferred $90 in credit, cash, etc. In one embodiment the $90 difference is paid by the third-party 101. In one embodiment the difference is paid by the third-party 101 out of collateral received from the seller 102.

Just as collateral can be authorized by the seller 102, in other embodiments collateral is authorized by the winning buyer 104. Put differently, in some embodiments the third-party 101, or the seller 102, require collateral from potential buyers 104. In one embodiment this collateral, which can be in the same forms previously described, is a pre-condition before a bid price 106 will be accepted from the potential buyer 103.

A few examples illustrating the collateral are provided for illustrative purposes.

### Example 3

Assume the Example 2 wherein the winning bid price 108 is $1.00. If the seller 102 refuses to transfer the item 111 to the wining buyer 104, upon notification of the refusal by either the seller 102 or the winning buyer 104, or upon an agreed upon passage of time without the transaction becoming complete, the third-party 101 collects collateral in the amount of $100. Thereafter, the third-party 101 transfers the difference to the winning buyer 104, in this case $100 less the winning bid price 108 of $1.00 and the winning bid fee 107 of $0.50 for a difference of $89.50. In one embodiment the same or similar solution arises if the item 111 is not in working condition when it reaches the winning buyer 104.

In one embodiment the seller 102 does not receive any of its fees, such as the bid fee payout 110 or the purchase payout 112, until after the transaction has been complete. In one embodiment, a transaction is assumed to be complete after the passage of an agreed upon amount of time following a winning bid.

One embodiment includes a “purchase now” option provided by either the third-party 101 or the seller 102. In one such embodiment potential buyers 103 are presented with a purchase now price at which they can purchase the item 111. In one embodiment the potential buyer's 103 fees, such as the bid fees 105, are credited toward the purchase now price. Thus, if a seller 102 is selling a camera and offers a purchase now price of $100, if an unsuccessful potential buyer 103 has $50 in bid fees, the potential buyer 103 can purchase the camera for $50. In one embodiment the third-party 101 credits the seller 102 with the third-party's 101 portion of the bid fees when the potential buyer 103 exercises the purchase now price option. In other embodiments, the third-party 101 retains at least a portion of the bid fees if the potential buyer 103 exercises the purchase now price option.

In one embodiment the bid fee 105 is fixed, or static, as described above. In another embodiment the bid fee 105 is dynamic, meaning the bid fee 105 can change and is thus not constant. In one embodiment an algorithm is used to determine the bid fee 105. The algorithm can include a variety of variables including bid price 106, time remaining in the auction, number of bids previously submitted by the potential buyer, among others. The bid fee 105 based upon the algorithm can increase or decrease based on these factors. For example, in one embodiment the algorithm calculates the bid fee 105 based upon the amount of time remaining in the auction. If a resetting auction is utilized, the algorithm can increase or decrease the bid fee 105 based upon time remaining As an example, in one embodiment the bid fee 105 increases as the time remaining in the auction decreases. Thus, if the bid fee 105 is typically $0.50, then this bid fee 105 will increase to $0.60 when there are ten seconds, as an example, remaining in the auction. Such an algorithm encourages potential buyers to submit bids early in the auction rather than waiting until the last second. Likewise, the algorithm can decrease the bid fee 105 to encourage bids in the final seconds. Thus, if the initial bid fee 105 is $0.50 then bid fee 105 can be decreased to $0.40 when ten seconds are remaining in the auction. As stated, these times are given for illustrative purposes only and should not be deemed limiting. In one embodiment the potential buyer 103 is made aware of the bid fee 105 before submitting the bid. This is particularly helpful with a dynamic bid fee 105 as the potential buyer 103 is aware of the amount, possibly a new amount, of the bid fee 105.

In another embodiment the algorithm takes into account the number of previous bids potential buyers 103 have submitted on the particular item 111. For example, if a potential buyer 103 has already submitted ten bids at $0.60, the algorithm may reward the potential buyer 103 by lowering the bid fee 105 to $0.50. This encourages potential buyers 103 to keep bidding while simultaneously rewarding them for their previous bids.

As noted the algorithm can account for a variety of factors, or it may rely only upon one or two factors, such as time or number of bids as discussed above. Thus the algorithm can be a complex algorithm which accounts for multiple variables or it can be a simple table matching bid fees 105 with various variables. In one embodiment the algorithm is stored and performed by a server.

The above examples illustrate that in some embodiments the seller 102 and buyer 104 can simultaneously obtain great deals. This is counter-intuitive and an unexpected result. In a traditional buyer-seller relationship, if the buyer gets a great deal this comes at the expense of the seller. Likewise, if the seller gets a great deal this comes at the expense of the buyer. Providing a method of sale which allows both the buyer and seller to achieve great and beneficial deals is an unexpected result. One advantage of this method is that both the buyer 104 and seller 102 will be satisfied and thus become repeat customers of the third-party 101.

Another unexpected result, in one embodiment, arises when the seller 102 comprises multiple items 111 to sell. For example, consider a retail store which sells cameras. Utilizing one embodiment of the method described herein, the retail store can utilize the law of averages in selling its product at a profit. For example, while some items may be sold below cost, other items will be sold significantly above cost when factoring in the purchase payout 112 and the bid fee payout 110. By having multiple items 111, the retail store owner can tolerate any losses while capitalizing on any sales above retail cost.

An additional unexpected result for sellers 102 with multiple items 111 is the goodwill which associates the transaction. As noted, the winning buyer 104 often wins the item 111 at below retail value. As such, the winning buyer 104 is often very happy with the transaction and carries much good will toward the seller 102. Such good will can often bring about additional sales. Additionally, when the seller 102 offers services, regardless of whether the services are sold at above or below cost, the seller/service provider 102 begins a relationship with the winning buyer 104.

Finally, another unexpected advantage of the third-party 101 facilitating the sale between the seller 102 and the potential buyers 103 is that the risk of the sale is on the seller 102. Put differently, if the item is sold below cost, that loss is absorbed by the seller 102. The third-party 101 receives some fee regardless of how much of a loss the seller 102 receives. Thus, any risk in the transaction is borne by the seller 102 as opposed to the third-party 101. By having the seller 102 bear the risk the third-party 101 can garner significant good will from winning buyers 104 who can receive excellent deals without having to share any of the potential losses associated with the good deals. Sellers 102, despite possible losses, are still desirous to list sell their item through the third-party 101 because, as noted above, the seller 102 can often receive significantly more than the retail price of the item by selling through the third-party 101.

As noted, the above method can be performed in a live in-person auction or it can take place on-line. In such an on-line embodiment, the potential buyers 103 submit their bid price 106 by placing a bid at a computer, smart phone, or other such device which is connected to the internet. The bid price 106 can be submitted by accessing the third-party 101 and submitting a bid. In one embodiment the bid is electronic. The bid price 106 can be submitted via email or other such notification. In another embodiment the bid price 106 is submitted by placing a bid on the third-party 101 website. The bid price 106 is then received by a computer, server or other such device utilized by the third-party 101. As noted, the third-party 101 can comprise a website which the potential buyers 103 access. The third-party 101 can then advise other potential buyers 101 of the new bid price 106.

As noted in one embodiment the method takes place on-line such as over the internet. There are many advantages to such an embodiment. First, being on-line significantly opens the pool of potential buyers 103. A live auction is limited to the potential buyers 103 which are physically present. On-line auctions allow potential buyers 103 from virtually any place in the world. Consequently, you have much more potential buyers 103. Second, often potential buyers 103 are more likely to make a bid on-line than in person. There are several reasons for this. For example, during live auctions potential buyers can view competing potential buyers' 103 energy and passion for the item. This may dissuade other potential buyers 103 from bidding knowing they will likely get outbid. Also, they may see what appears to be a very wealthy potential buyer 103 and decide it best not to compete with such wealth. An on-line auction overcomes these and other issues.

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.

1. A method of selling an item, said method comprising the steps of:
a. soliciting at least one bid for said at least one item from at least one potential buyer, wherein at least one of said at least one bids comprises a bid fee and a bid price;
b. receiving a winning bid from a winning buyer, wherein said winning bid comprises a winning price;
c. remitting at least a portion of said winning price and at least a portion of said bid fee to said buyer.
   2. The method of clause 1 further comprising calculating the cumulative bid fees from all bids.
   3. The method of clause 2 wherein said remitting of step c) comprises remitting at least a portion of said cumulative bid fees to said winning buyer.
   4. The method of any preceding clause wherein steps a) through c) are performed by a third-party to said seller and said wining buyer.
   5. The method of any preceding clause wherein steps a) through c) are performed by a third-party to said seller and at least one potential buyer.
   6. The method of any preceding clause wherein said method further comprises the step of making contact with a seller, wherein said step of making contact with said seller occurs prior to said soliciting of step a).
   7. The method of any preceding clause wherein said soliciting of step a) comprises active solicitation.
   8. The method of any preceding clause wherein said soliciting of step a) comprise passive solicitation.
   9. The method of any preceding clause wherein said soliciting comprises accepting bids submitted through a computer.
   10. The method of any preceding clause further comprising the step of specifying an initial bid price.
   11. The method of clause 10 wherein said initial bid price is set by said seller.
   12. The method of any preceding clause further comprising specifying a bid price increment.
   13. The method of clause 12 wherein said bid price increment is specified by said seller.
   14. The method of any preceding clause further comprising the step of obtaining collateral from said seller.
   15. The method of clause 14 wherein said collateral is equal to the value of said item.
   16. The method of clauses 14 or 15 further comprising the step of transmitting at least a portion of said collateral to said winning buyer.
   17. The method of any preceding clause further comprising the step of making the winning buyer whole.
   18. The method of any preceding clause wherein step b) comprises soliciting at least two bids.
   19. The method of any preceding clause wherein said soliciting of step b) comprises a resetting auction.
   20. The method of any preceding clause wherein said soliciting of step b) comprises a simple auction.
   21. The method of any preceding clause further comprising the step of verifying said item is transferred to said winning buyer.
   22. The method of clause 21 wherein said verifying occurs prior to said remitting of step c).
   23. The method of clause 21 wherein said verifying occurs after said remitting of step c).
   24. The method of any preceding clause wherein said soliciting of step b) comprises a purchase now option.
   25. The method of any preceding clause wherein said remitting of step c) comprises remitting all of said winning price to said seller.
   26. The method of any preceding clause wherein said bid fee is static.
   27. The method of any preceding clause wherein said bid fee is dynamic.
   28. The method of any preceding clause wherein said bid fee is calculated by an algorithm.
   29. The method of clause 28 wherein said algorithm includes time remaining as a factor.
   30. The method of clause 28 wherein said algorithm includes the number of bids submitted by a potential buyer as a factor.
   31. The method of any preceding clause wherein said bid price comprises a buyer set bid price.
   32. The method of any preceding clause wherein said bid price comprises at least one bid price increment.
   33. The method of clause 32 wherein said at least one bid price increment is set by the third-party.
   34. The method of clauses 32 or 33 wherein said bid price comprises at least two dissimilar bid price increments.
   35. The method of clause 34 wherein said two dissimilar bid price increments change upon the happening of an event.
   36. The method of clause 35 wherein said happening of an event comprises obtaining a specified bid price.

What is claimed is:

1. A method of selling an item, said method comprising the steps of:
a. soliciting at least one bid for said at least one item from at least one potential buyer, wherein at least one of said at least one bids comprises a bid fee and a bid price;
b. receiving a winning bid from a winning buyer, wherein said winning bid comprises a winning price;
c. remitting at least a portion of said winning price and at least a portion of said bid fee to said buyer.

2. The method of claim 1 further comprising calculating the cumulative bid fees from all bids.

3. The method of claim 2 wherein said remitting of step c) comprises remitting at least a portion of said cumulative bid fees to said winning buyer.

4. The method of claim 1 wherein steps a) through c) are performed by a third-party to said seller and at least one potential buyer.

5. The method of claim 1 wherein said soliciting comprises accepting bids submitted through a computer.

6. The method of claim 1 further comprising the step of specifying an initial bid price.

7. The method of claim 1 further comprising the step of obtaining collateral from said seller.

8. The method of claim 7 further comprising the step of transmitting at least a portion of said collateral to said winning buyer.

9. The method of claim 1 wherein step b) comprises soliciting at least two bids.

10. The method of claim 1 wherein said soliciting of step b) comprises a resetting auction.

11. The method of claim 1 wherein said soliciting of step b) comprises a simple auction.

12. The method of claim 1 further comprising the step of verifying said item is transferred to said winning buyer.

13. The method of claim 12 wherein said verifying occurs prior to said remitting of step c).

14. The method of claim 1 wherein said soliciting of step b) comprises a purchase now option.

15. The method of claim 1 wherein said bid fee is dynamic.

16. The method of claim 1 wherein said bid fee is calculated by an algorithm.

17. The method of claim 16 wherein said algorithm includes time remaining as a factor.

18. The method of claim 16 wherein said algorithm includes the number of bids submitted by a potential buyer as a factor.

19. The method of claim 1 wherein said bid price comprises at least one bid price increment.

20. The method of claim 19 wherein at least one bid price increment comprises at least two dissimilar bid price increments, and wherein said at least two dissimilar bid price increments change upon the happening of an event.
